(19) United States
(12) Patent Application Publication
(10) Pub. No.: US 2025/0344920 A1
(43) Pub. Date: Nov. 13, 2025

(54) DEBRIS CONTAINMENT SYSTEM FOR A CANISTER VACUUM

(71) Applicant: Gary C. Chambers, Port Orange, FL (US)

(72) Inventor: Gary C. Chambers, Port Orange, FL (US)

(21) Appl. No.: 18/657,894

(22) Filed: May 8, 2024

(51) Int. Cl. A47L 9/14; A47L 7/00; A47L 9/00; B26B 27/00

(52) U.S. Cl. CPC A47L 9/1481; A47L 7/0023; A47L 9/009; A47L 9/1427; B26B 27/00

(57) ABSTRACT

A debris containment system for a canister vacuum allowing use of a common trash bag as a debris containment bag during vacuuming to in turn provide for a cleaner and less strenuous method of emptying debris from a canister vacuum.

### BACKGROUND

The present invention relates to canister vacuums. More specifically, to components of a canister vacuum used to contain vacuumed up debris.

Canister vacuums employ a canister and either house a filter bag attachable inside the canister for debris collection and containment with filtering of the exhaust air, or alternatively, utilize the canister itself for the debris containment, and employ a separate exhaust air filtering system. Household vacuum cleaners typically utilize the filter bag design. Regarding the other type that utilizes the canister for debris containment, one must empty the canister into another container or garbage type bag for disposal. It is well known that emptying a canister can be a very dirty and sometimes unhealthy job. It can also be physically demanding such as when emptying debris from a canister or a canister having wheels and a cart attached, or one that is simply heavily loaded with debris. Lifting a canister loaded with debris and dumping that debris is not a pleasurable task.

Accessories are available for some of these canister vacuums that provide filter bags attachable inside the canisters. This can make for an easier and cleaner process when emptying the canister vacuum. These particular accessories however were designed for another purpose. They are designed to provide additional exhaust air filtering for when vacuuming up fine dust particles, and in turn are fairly complex and expensive. The need for this fine filtering arises for example when vacuuming fine dust particles produced after sanding sheetrock in a house. The accessory is constructed similarly to the common household canister vacuum cleaner filter bag, which utilizes multiple layers of filtering material to allow the high volume of suction air needed for vacuuming to be drawn into and then out through the walls of the filter bag, while at the same time, capturing and retaining fine dust type debris.

Additionally, these filter bag accessories significantly reduce the debris collection capacity of the canister vacuum when compared to the manufacturer's original specified capacity. The multi-layered and relatively stiff bags fail to utilize all of the debris collection space available. This in turn leads to more frequent canister vacuum emptying and replacement of these fairly expensive bags. Again, these filter bags are intended to provide extra fine filtering and dust control and containment of the fine dust. They are not intended for the more common everyday use where the manufacturer's filtering system is sufficient.

### SUMMARY

The present invention discloses components that allow the use of a common trash bag for debris containment and disposal, instead of allowing the debris to simply pile up inside of the vacuum canister itself. The present invention provides this benefit by employing a bag retainer. The bag retainer is installable within a canister vacuum canister and prevents a light weight bag from being drawn up onto the canister vacuum filter and blocking the suction air needed for vacuuming. The present invention also discloses additional components that may be useful depending on a manufacturer's canister design. These additional components include a bag retaining washer and a bag removal guide. Additionally, the present invention discloses a bag cutter, a debris containment bag designed specifically for this purpose, as well as a canister configured to optimize use of low-cost containment bags. Capturing and containing the debris within a trash bag can provide for a cleaner and less strenuous process of emptying a canister vacuum.

### BRIEF DESCRIPTION OF THE DRAWINGS

FIG. 1a is a partial cutaway view to illustrate a typical canister vacuum.

FIG. 1b is a view of the typical canister vacuum canister of FIG. 1a.

FIG. 1c is a view of another conventional canister vacuum canister configuration.

FIG. 1d is a view of yet another conventional canister vacuum canister configuration.

FIG. 1e is a view of still another conventional canister vacuum canister configuration.

FIG. 1f is illustration of another conventional canister vacuum canister with a can shaped vessel.

FIG. 1g depicts a conventional canister vacuum canister with the inlet pipe passing through the wall of the canister.

FIG. 2a is a partially transparent view to depict a debris containment trash bag installed within the conventional canister of FIG. 1g.

FIG. 2b is a partially transparent view to depict a debris containment trash bag installed within the conventional canister of FIG. 1f.

FIG. 3a depicts one possible bag retainer of the present invention.

FIG. 3b depicts a substantially rectangular shaped bag retainer.

FIG. 3c depicts another possible bag retainer of the present invention.

FIG. 4a depicts the cylindrical bag retainer in FIG. 3a installed inside debris containment bag of FIG. 2a installed within the canister of FIG. 1g.

FIG. 4b depicts the cylindrical bag retainer in FIG. 3c installed inside debris containment bag of FIG. 2b installed within the canister of FIG. 1f.

FIG. 5 depicts an alternative bag retainer.

FIG. 6 depicts the bag retainer of FIG. 5 installed inside the debris containment bag of FIG. 2a installed within the canister of FIG. 1g.

FIG. 7 depicts an alternative bag retainer sleeve.

FIG. 8a depicts still another alternative bag retainer.

FIG. 8b illustrates the bag retainer of FIG. 8a installed within the canister of FIG. 1g.

FIG. 9 depicts one possible bag removal guide.

FIG. 10 is a partial cutaway view of the bag removal guide of FIG. 9 installed within the canister of FIG. 1g.

FIG. 11 is a partial cutaway view of the bag retainer of FIG. 7 installed with bag removal guide of FIG. 9 inside the canister of FIG. 1g.

FIG. 12 is a partial section view to illustrate placement of the bag removal guide of FIG. 9.

FIG. 13 is an illustration depicting a bag removal guide configured to be permanently fastened within a canister.

FIG. 14 depicts a bag retaining washer.

FIG. 15 depicts a partial section view of the bag retaining washer of FIG. 13 installed over a debris inlet pipe for use with a shortened bag retainer.

FIG. 16 depicts cuts that can be made in a trash bag for installation over a debris inlet pipe.

FIG. 17 depicts the bag of FIG. 16 installed over a debris inlet pipe.

FIG. 18 depicts a one possible design for a bag cutter.

FIG. 19a depicts a partial section view of one possible canister of the present invention configured to optimize use of a trash bag for debris containment.

FIG. 19b depicts a partial section view of another possible canister configuration of the present invention configured to optimize use of a trash bag for debris containment.

FIG. 19c depicts a possible bag retainer for possible use within the optimized canister of FIGS. 19a and 19b.

### DETAILED DESCRIPTION

It is noted that the vacuums being referred to in the specification below are canister vacuums, central vacuums, drum vacuums, wet/dry vacuums or shop vacuums.

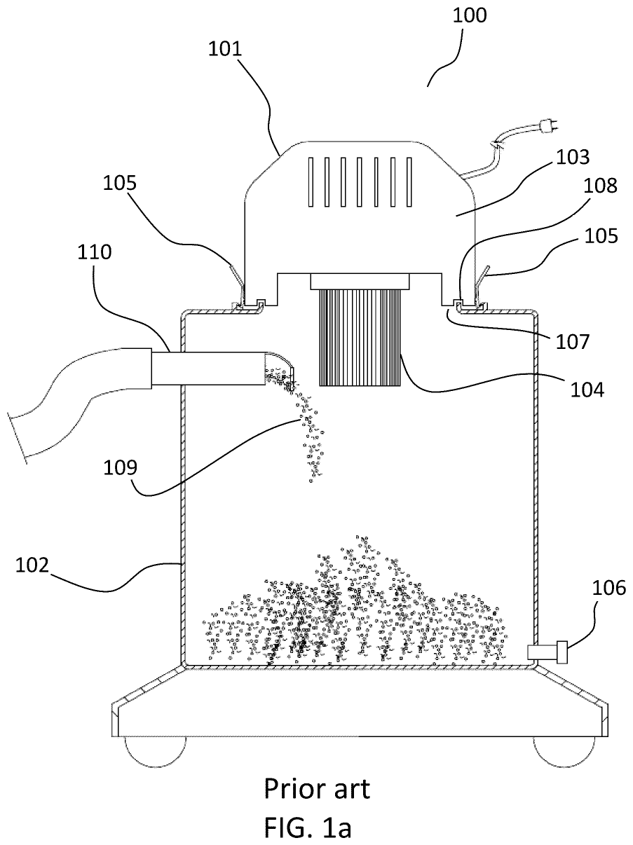

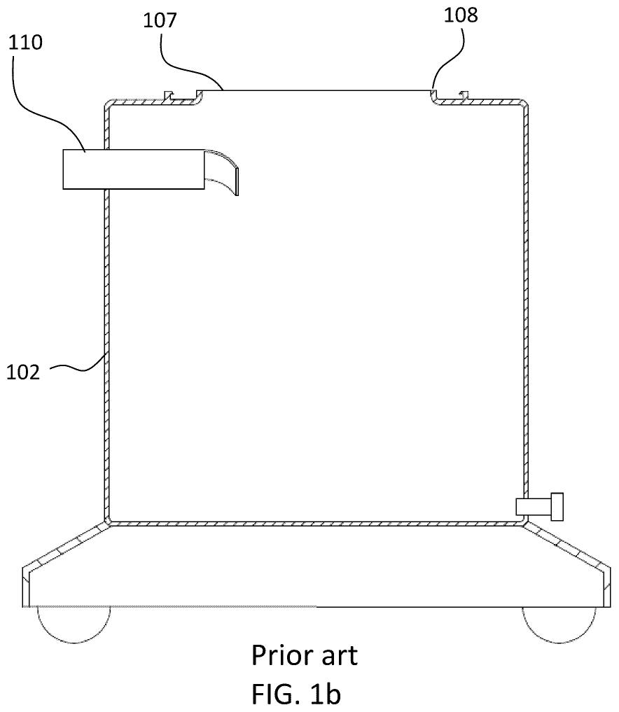

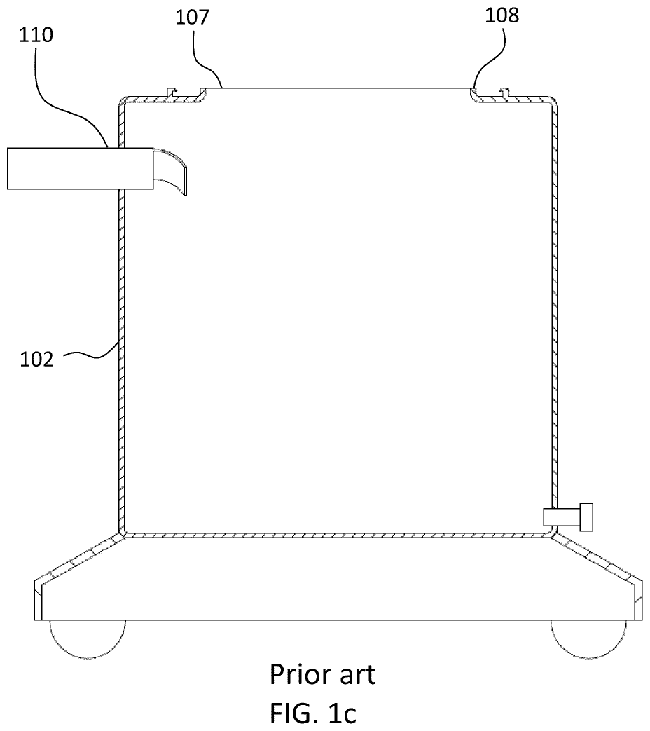

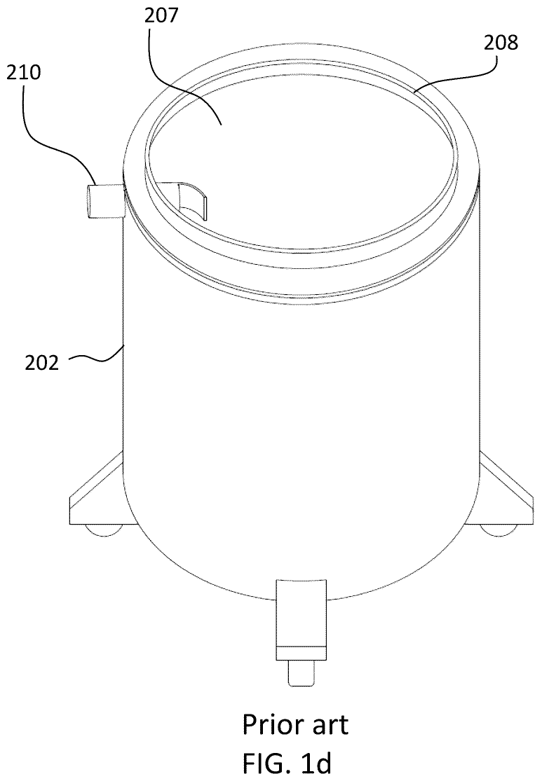

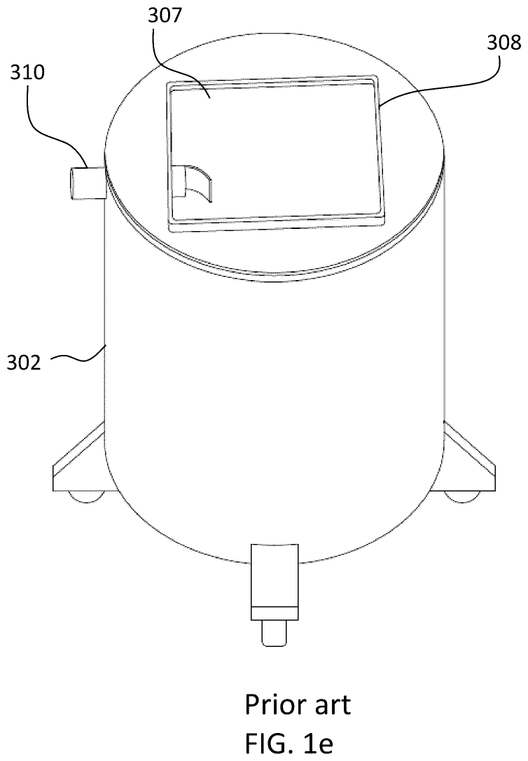

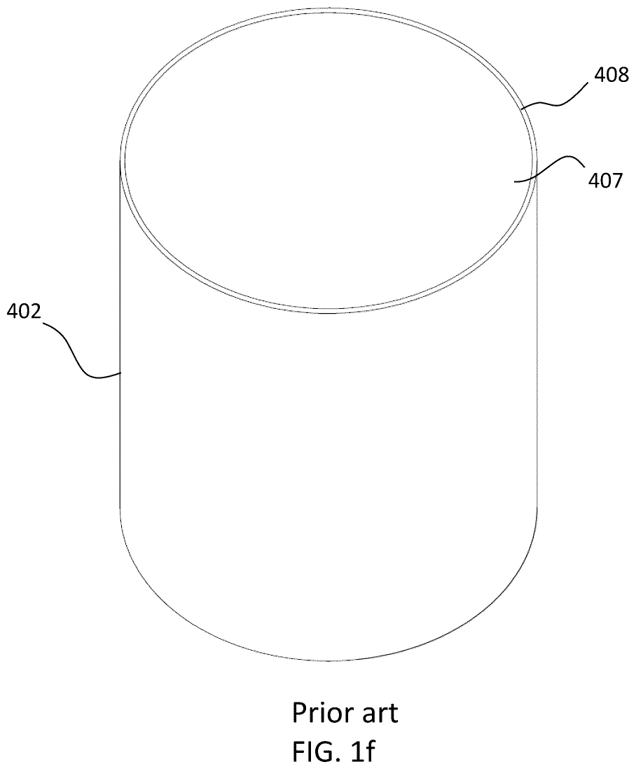

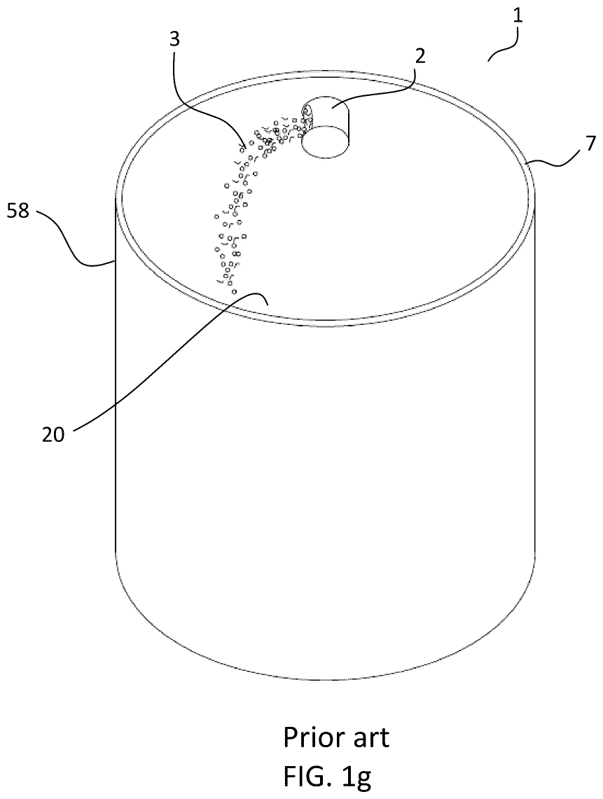

FIG. 1a is an illustration depicting a type of canister vacuums known as the shop vacuum. The canister vacuum 100 has a powerhead 101 and a canister 102. The powerhead 101 is a removable upper portion of canister vacuum 100. The housing 103 of the powerhead 101 includes a drive motor and fan (not illustrated). Powerhead 101 also comprises a cartridge air filter 104 to provide filtering of the suction air being exhausted from inside canister 102 during operation, plus latches 105 used to secure powerhead 101 to the canister 102 in a manner to provide sufficient sealing during vacuuming.

The canister 102 is sufficiently water tight and has a canister opening 107 bordered by a rim 108 and a debris inlet pipe 110. In this case where the canister vacuum is a wet/dry canister vacuum, a drain pipe 106 is provided for draining the canister 102 after vacuuming up liquid.

Additionally illustrated in FIG. 1a is debris 109 being channeled into canister 102 with the debris simply accumulating at the bottom of canister 102.

It is to be noted that as the debris 109 accumulates within canister 102, the debris will increase in volume and weight until the end user decides to empty the canister vacuum 100. After the user removes powerhead 101, the user must then lift canister 102 along with the collected debris 109 inside, and dump the debris 109 into something or somewhere for disposal. This is the strenuous and dirty task that makes emptying a canister vacuum an unpleasant task.

FIG. 1b-FIG. 1g illustrate just a few examples of various conventional canister shapes and configurations being manufactured, whereby the canister openings, canister rims, and debris inlet pipe positions can vary in size, shape and position respectively. The present invention discloses components which can be shaped and sized for a particular canister design to allow installation and use of a trash bag for the containment of debris.

FIG. 1b illustrates canister 102 of FIG. 1a to illustrate debris inlet pipe 110 positioned in a location that is visible when looking straight down through canister opening 107. Inlet pipe positioning defines the shape of one or more components of the present invention discussed in more detail below.

FIG. 1c illustrates debris inlet pipe 110 positioned so not to be visible when looking straight down through canister opening 107. It is noted that this alternative position does not obstruct the installation of components of the present invention.

FIG. 1d illustrates a canister 202 having a substantially circular shaped canister opening 207 with a concentric rim 208. Also illustrated is an inlet pipe 210 that is located in a position that is visible when looking down through opening 207.

FIG. 1e illustrates yet another canister 302 designed having a substantially rectangular shaped canister opening 307 with rectangular shaped rim 308. Inlet pipe 310 is visible when looking straight down through opening 307.

FIG. 1f represents another type of canister whereby the canister is a can shaped vessel 402 having a top rim 408 defining top opening 407. Top rim 408 would comprise of a formed shape that allows for attachment to an upper power head section. This type of canister design can be found on central vacuums, drum vacuums, and a new type of shop vacuum where a power head simply attaches to the rim of a 5-gallon pail. In canister vacuums such as these where the canisters are can shaped vessels, a debris inlet pipe is mounted in the power head section and directs the incoming debris down through top opening 407 into the canister.

For the purpose of this disclosure, illustrations and discussions will consider use of a debris inlet pipe installed through the canister side wall, as this requires additional consideration. This type of configuration will require an addition of an opening in the debris containment trash bag, plus an opening through or provided above, the bag retainer. These openings are required to allow the flow of debris entering through a debris inlet pipe located in the side wall of the canister, to deposit inside the containment trash bag. This will be discussed in more detail.

It is therefore noted that when an inlet pipe is not located in the canister, there is no need for added openings in a trash bag side wall or bag retainer to allow the debris to deposit into the trash bag. The openings shall be understood to simply be the top open end of the trash bag, and the top opening of the bag retainer.

FIG. 1g illustrates another type of conventional canister vacuum canister 1 having a debris inlet pipe 2 that protrudes through the circumferential wall 58 of canister 1 and into view when looking straight down through canister opening 20. Also depicted is inlet pipe 2 channeling a flow of debris 3 into canister 1. FIG. 1g further illustrates a rim 7 bordering canister opening 20.

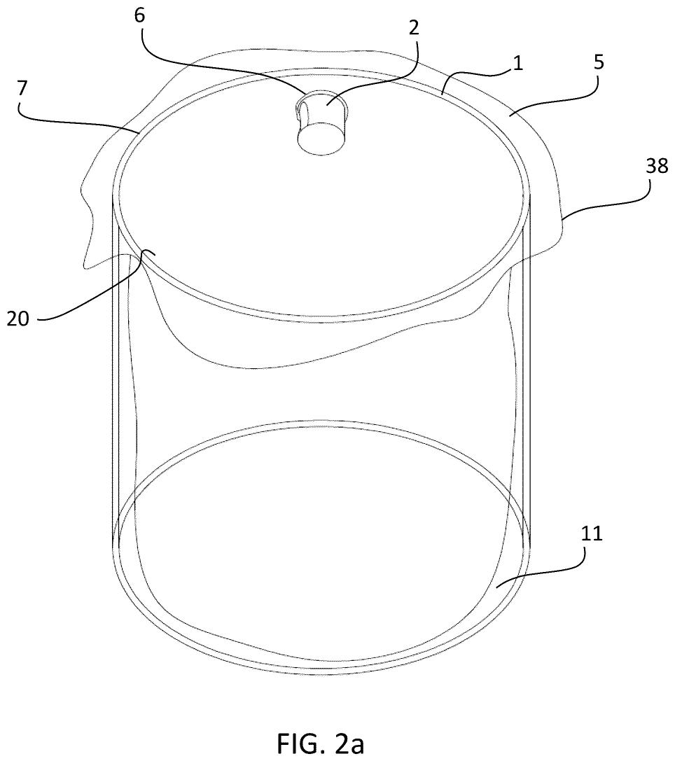

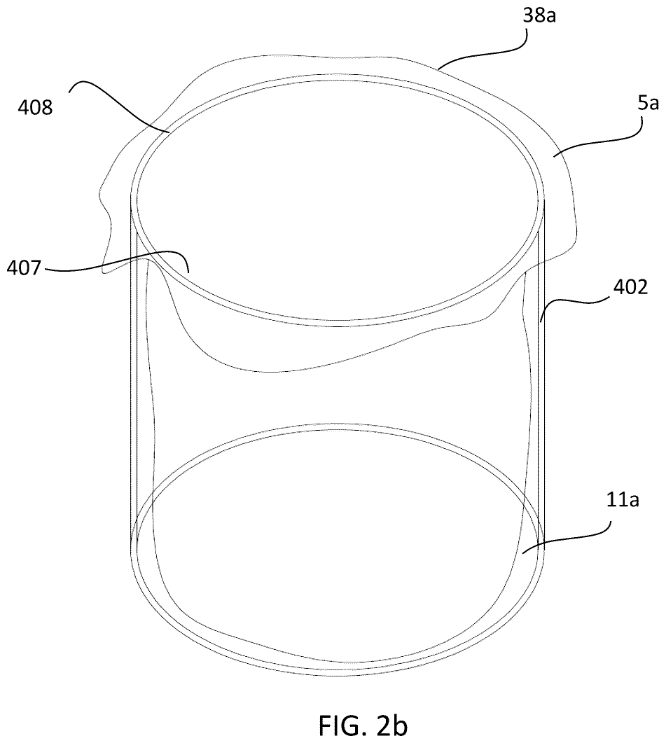

FIG. 2a is a partially transparent view of a canister 1 to illustrate the present invention's use of a trash bag 5 for debris containment and removal. It is noted that the present invention allows use of the common, low cost trash bag which is understood to include at least: the common household or kitchen garbage bag, lawn trash bags, contractor bags, etc., and may be referred to throughout this disclosure as a “trash bag” or a “debris containment bag” or simply “containment bag” or just “bag”. It is also noted that the present invention further discloses a containment bag that is configured specifically for use in a canister vacuum.

FIG. 2a illustrates bag 5 in the installed position inside canister 1 and resting on the floor 11 of the canister 1. Bag 5 also includes a cut bag opening 6 having been previously created in bag 5 and positioned over the canister vacuum debris inlet pipe 2 to now allow the debris to enter and accumulate within bag 5 instead of simply depositing and accumulating within the canister itself. Containment of the debris within bag 5 can now provide the benefit of emptying the debris by simply removing the debris bag.

FIG. 2a further depicts the entire length of the top edge 38 of bag 5 extending out of canister 1 opening 20 and draped over rim 7 of the canister 1. When the canister vacuum power head is attached, the canister vacuum power head will retain bag 5 in place over rim 7.

FIG. 2b is a partially transparent view of canister 402 of FIG. 1f. FIG. 2b illustrates a trash bag 5a in the installed position and resting on floor 11a of canister 402, with the top edge 38a of bag 5a extended and draped over rim 408 of canister 402. Again note that there is no debris inlet pipe in canister 402. This therefore does not require an added opening in the side wall of trash bag 5a for an inlet pipe. The debris will simply enter from an inlet pipe located above, directing the debris into the bag.

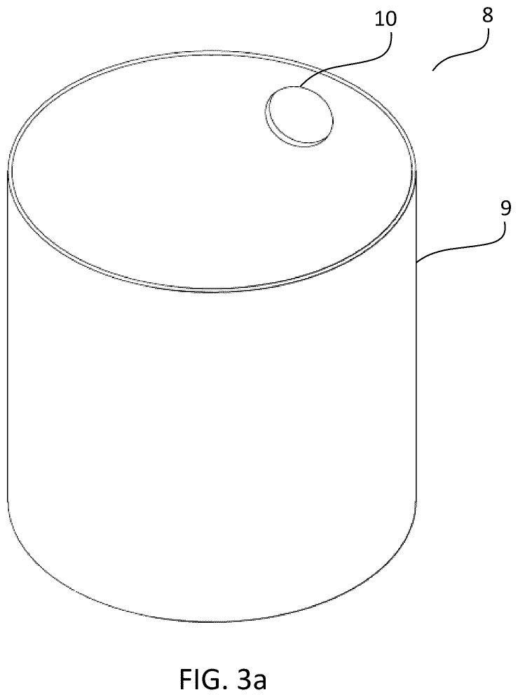

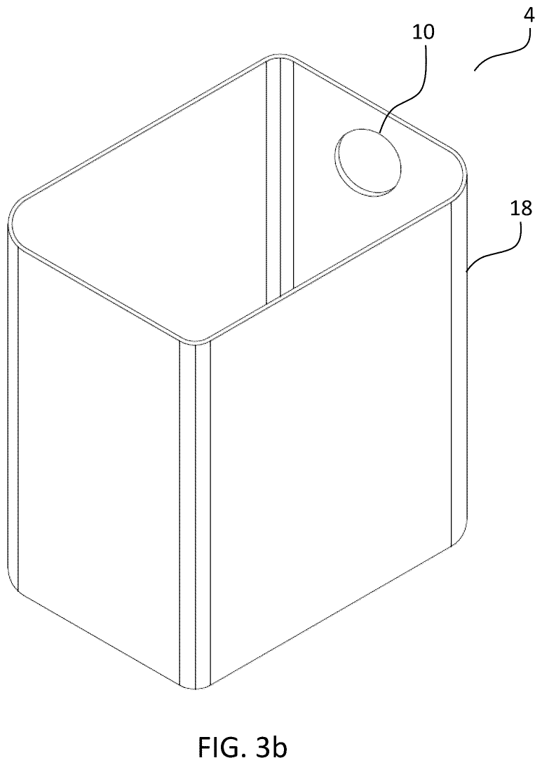

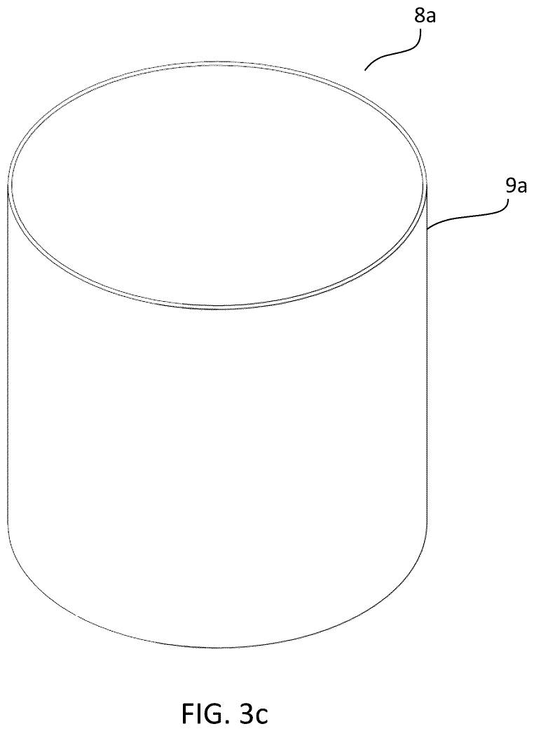

FIG. 3a depicts one possible design of a bag retainer of the present invention for use in a canister having an inlet pipe. An advantage of the bag retainer of this embodiment is the simplicity of the design and the low cost of manufacturing.

FIG. 3a depicts bag retainer 8 for use in canister 1 of FIG. 2 and is comprised of a single hollow sleeve 9 with of an outer diameter that is slightly smaller than opening 20 of canister 1. It is noted that a bag retainer does not have a bottom and is comprised of a shape along its length that allows the bag retainer to be removed from the debris bag with minimal debris being pulled out with it. It should also be noted that the upper opening of the many available canister vacuums can be of various shapes and sizes as previous illustrated. A bag retainer of the present invention must be able to drop down through the top opening of the canister for installation. Clearance between a canister opening and a retainer may vary depending upon the use of other optional components of the present invention (to be discussed later) but needs to provide acceptable clearance for ease of installation and removal by the end user. It is noted that there is assumed to be an 8 to 10 mm clearance all around.

It is preferred that at installation of a retainer, the retainer comes to rest atop the bag on the floor of the canister vacuum canister. This will help prevent the bag from lifting up and contacting the canister vacuum air filter. Additionally and for the benefit of the end user, when a bag retainer is sized to fit down through the canister opening and come to rest atop the bag on the floor of the canister, the arrangement will help retain the accumulated debris in a shape that will help the end user remove the bag out through the canister opening. Optional components of the present invention can also be employed to better help bag removal.

The bag retainer 8 in FIG. 3a is illustrated being extended to an upward height that is level with the rim 7 of canister 1. The extended upward height of the bag retainer might only need to extend up near the bottom of the inlet pipe, or can be extended near to, but not interfere with, the installed powerhead. This can be determined when designing a retainer for a particular size and shaped canister.

FIG. 3a additionally illustrates an opening 10 through sleeve 9 of a size and shaped to fit over the debris inlet pipe 2 of FIG. 2. The clearance must be sufficient to allow for installation over debris inlet pipe 2 but may also be varied in size or shape.

FIG. 3b illustrates a different shaped bag retainer 4 having a substantially rectangular shaped hollow sleeve 18 that could be used in a canister similar in design to canister 302 of FIG. 1e. Retainer 4 also includes an opening 10 for installation over a debris inlet pipe. FIG. 3b is simply an illustration of another possible shape of bag retainer to fit a different shape canister opening. Again, there are many sizes and shapes of canisters having different opening sizes and shapes. The bag retainer of the present invention must always be able to be installed (and removed) through the opening of the canister.

FIG. 3c depicts a bag retainer 8a comprised of a single hollow sleeve 9a for use in canister 402 of FIG. 2b and having an outer diameter slightly smaller than the opening 407 of canister 402 in FIG. 2b.

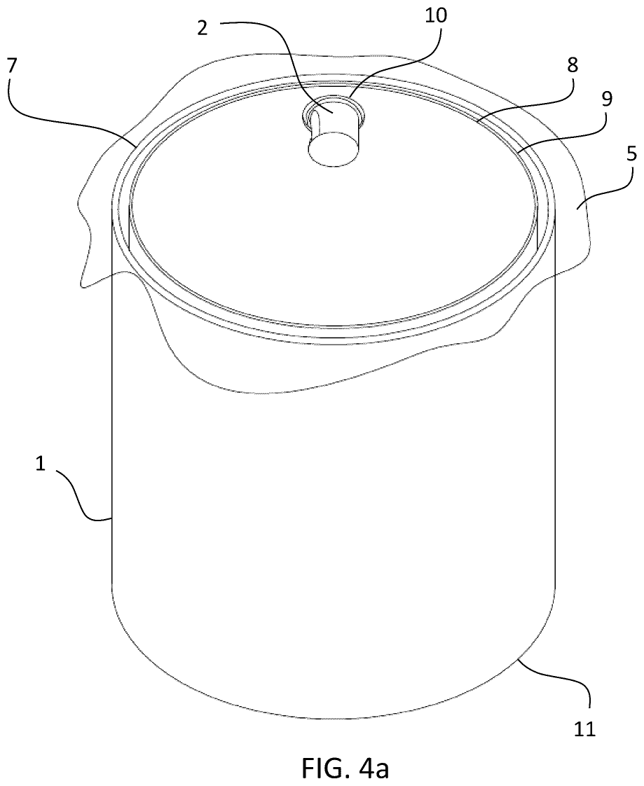

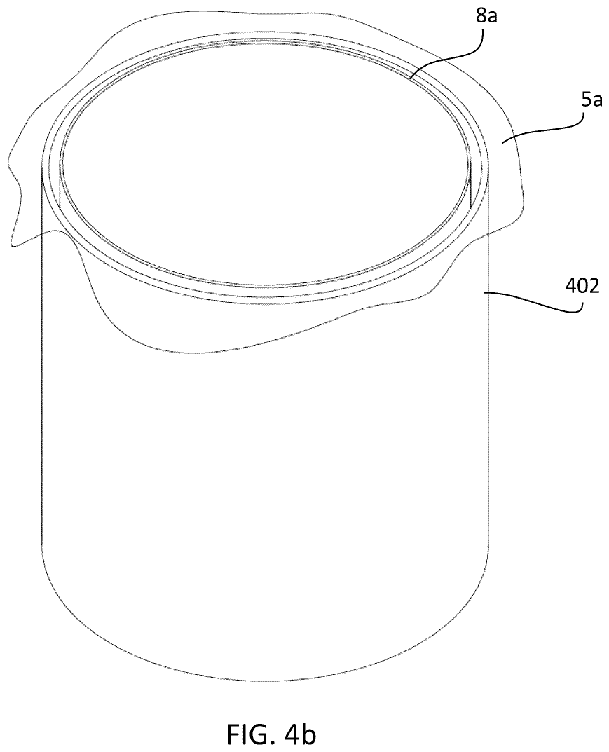

FIG. 4a depicts retainer 8 of FIG. 3a installed within canister 1 of FIG. 2a. Retainer 8 is installed after installation of bag 5 such that the retainer 8 is positioned inside of containment bag 5 to prevent bag 5 from being drawn onto the canister vacuum filter during operation.

Opening 10 is shown positioned over inlet pipe 2 and is required to allow the incoming debris to be deposited inside the containment bag 5. An opening 10 through the bag retainer 8 for the debris inlet pipe can be a round hole, or elongated hole, or a rectangular cutout, or open ended cutout, or another preferred shape.

It is important to note however that for retainer 4 or 8 to be able to be installed into a canister and over a debris inlet pipe, the sleeve material must be one that will both maintain its approximate original shape during the vacuuming operation, yet be flexible enough to be flexed around the debris inlet pipe as one slides the retainer downward into its final position within the canister, and then repeated in reverse for removal.

FIG. 4b depicts retainer 8a of FIG. 3c installed within trash bag 5a inside of canister 402 of FIG. 2b. This particular configuration of the present invention is for a canister vacuum where the debris inlet pipe is external of the canister with debris directed into trash bag 5a from above. It is important to note that this simplistic bag retainer design can also be used in canisters having an inlet pipe installed through the canister wall but must be constructed having an installed height that is below the inlet pipe and sufficient to retain the trash bag in position so not to contact the filter and impede the air flow needed during vacuuming.

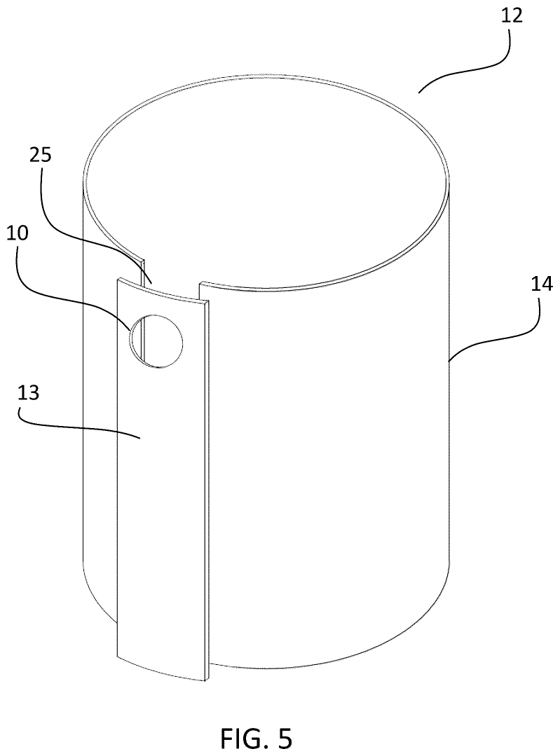

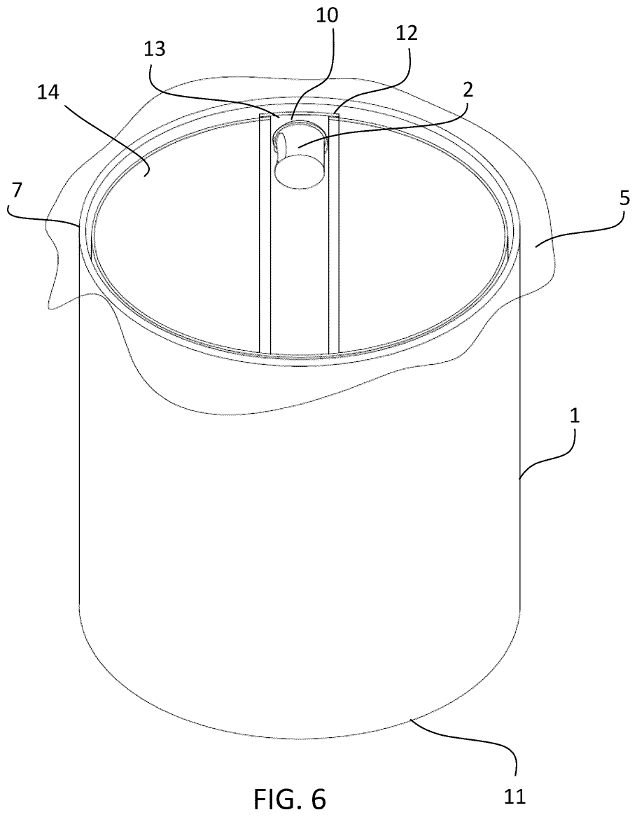

FIG. 5-FIG. 6 depict an alternative bag retainer 12 for canister 1, whereby the material is not required to be flexed around the debris inlet pipe during installation, but instead comprises a retainer sleeve with two sleeve sections.

FIG. 5 depicts a retainer 12 which extends upward to a height that will be level with rim 7 of canister 1 comprising a first sleeve section 13 and a second sleeve section 14. First retainer sleeve section 13 is a section of sleeve including an opening 10 for installation over inlet pipe 2 and would be installed first before installing second sleeve 14. Retainer sleeve section 14 is C-shaped with a section 25 removed along its entire length to provide for installation of sleeve 14 down along each side of debris inlet pipe 2.

Sleeve 14 is depicted having an approximate equal diameter along its length with the outer diameter being slightly smaller than the top opening diameter of canister 1 to allow for installation and removal. It must again be noted that a retainer 12 can be configured in various shapes to fit thru various shaped canister openings, but might also be configured with an unequal diameter along its length (such as having a slight tapered shape), but consideration must be made to help ensure that installation and removal of the bag retainer can occur without undue difficulty by the end user, and without unacceptable amounts of debris being pulled out with the retainer during retainer removal.

Sleeve 13 can also be formed with a radius, where the radius is approximately equal to or of a material thickness greater than the radius of sleeve 14, and of a width that allows sleeve 13 to overlap sleeve 14. There is no critical overlapping measurement, but one can consider 12 to 14 mm overlap on each side to be sufficient.

The length of retainer sleeve 13 should again be considered to extend down near to the canister floor. This is especially preferred with sleeve 13, as sleeve 13 is susceptible to a swinging movement. Sleeve 13 can be restricted in movement when positioned near the canister floor 11.

FIG. 6 is a partially transparent view to illustrate the installation of alternative bag retainer 12 installed inside of bag 5 inside of canister 1.

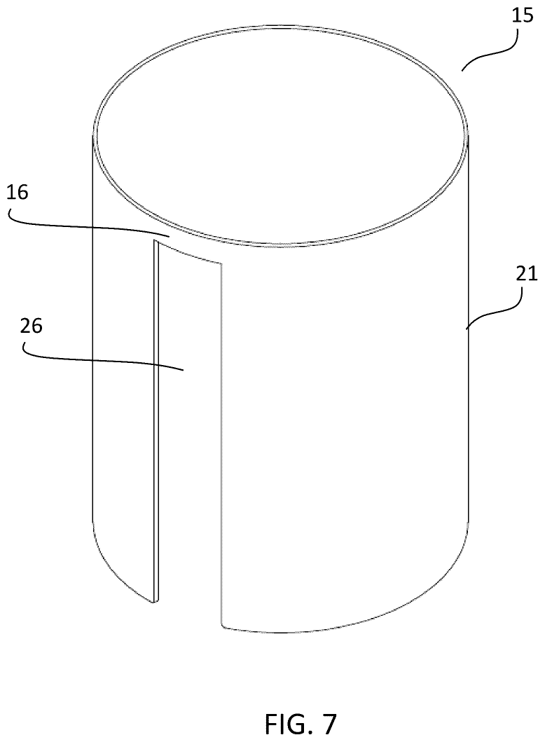

FIG. 7 depicts an alternate sleeve 21 that could be used alternatively in combination with sleeve 13 of FIG. 5.

FIG. 7 depicts a retainer sleeve 21 that is a hollow cylindrical sleeve that has a cut out 26 extending from a bottom end and extends a length. The cutout has edges defining the cutout as being rectangular in shape, but other shapes can be used. Between the top end of the cut out and the edge of the retainer sleeve is a connecting section 16. The upper connecting section 16 aids in retaining the shape of the retainer especially if a thinner material was used. Connecting section 16 could also be used as an installation and removal handle. Connecting section 16 can be shaped as depicted or be shaped with a radius to more fully surround the debris inlet pipe for additional structural strength, while possibly still allowing use as a handle.

Handles can be formed as part of the retainer to allow for greater ease of user installation and removal of a retainer or other components of the present invention. The handles can be formed as part of a component, or might be constructed separately and attached mechanically or chemically, etc. but should not have protrusions that could catch or even rip the bag during retainer installations or removals. It is also preferred that a handle either extend in a direction aligned with the direction of installation and removal, or angled inward so not to interfere with the installation or removal through the canister opening. Additionally, any handle on any component of the present invention must not interfere with the flow of debris, or impede the installation of the powerhead, or the air filter, or restrict the suction air flow for vacuuming. It may therefore be preferred that slots or cutouts within a sleeves itself be utilized, however, other types or forms of handles can certainly be employed.

In FIG. 7, it should be noted that sleeve 21 might also be used as a standalone single piece bag retainer 15. This is acceptable as long as the bag will be sufficiently retained during vacuum operation. Still further, sleeve 21 might be reconfigured to include multiple cut outs or removed sections 26. Still another possible configuration would be for retainer 15 to be of a shorter overall height that would extend from the canister floor to a height that is below the debris inlet pipe, whereby the open area left above provides for the opening required for the debris to enter past the retainer and into the containment bag, again as long as the retainer sufficiently retains bag 5 during the vacuuming operation.

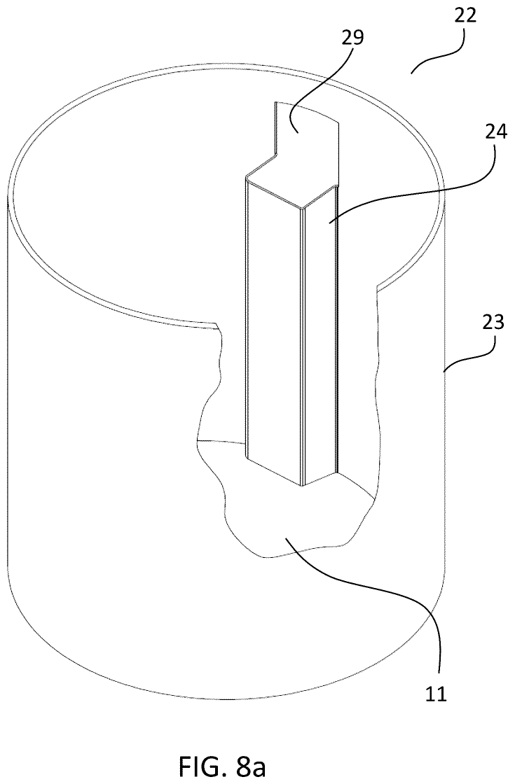

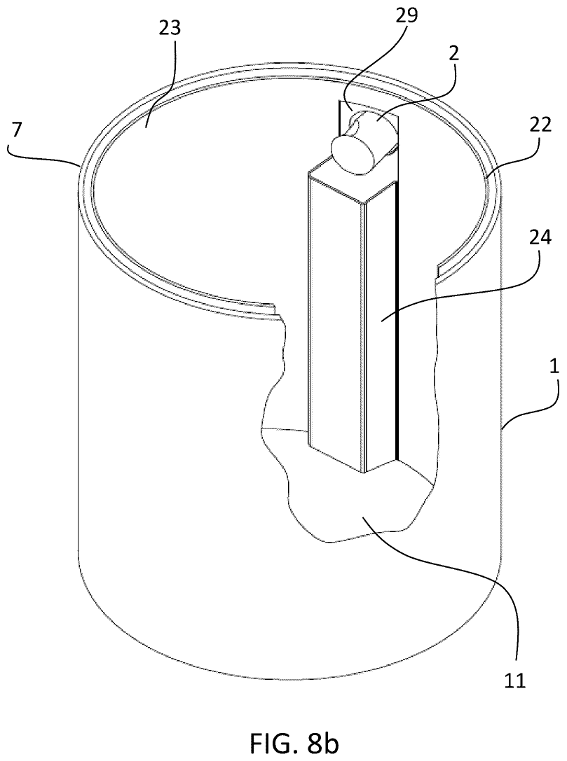

FIG. 8a-8b depict still another alternate bag retainer. Depicted is bag retainer 22 for use in canister 1. The alternative bag retainer 22 comprises a single piece hollow retaining sleeve 23 that includes a channel 24 that protrudes inward towards a center of the bag retainer 22 and dimensioned to surround (with clearance) the debris inlet pipe 2 during retainer installation. Bag retainer 22 is depicted having an approximate equal diameter along its length and of a length that rests atop the bag (not illustrated) on the floor 11 of the canister 1 with an upward height that extends upward to a height that is level with rim 7 of canister 1. Depicted bag retainer 22 is illustrated having an outer diameter slightly smaller than the opening of canister 1 for allowing installation and removal.

It must be noted that the depicted rectangular shaped channel 24 might alternatively be shaped to be trapezoidal in shape, or a semi-circular, or elliptical, or another desired shaped protrusion where it is still allows for installation of the bag retainer down over the inlet pipe and of a height that extends to below inlet pipe 2 so not to interfere with the inlet flow of debris.

Depicted in FIG. 8b is rectangular shaped opening 29 that provides the required opening for and clearance around inlet pipe 2. The opening shape can be circular, as illustrated by opening 10 in FIG. 5, or some other desired shape.

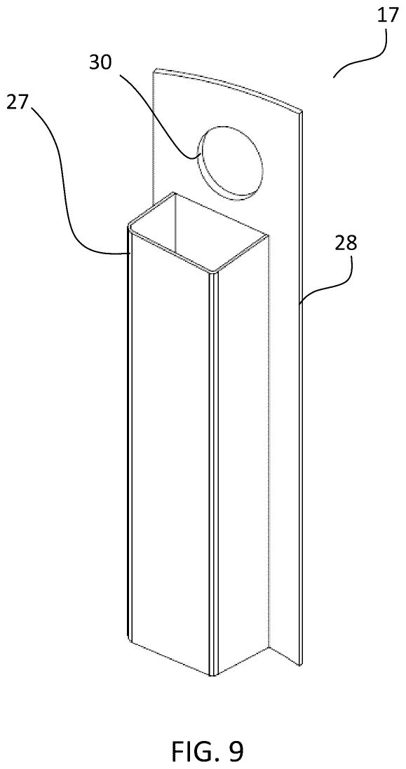

FIG. 9-12 depict an optional bag removal guide. The purpose of the optional bag removal guide is to help hold the debris containment bag away from a protruding debris inlet pipe during trash bag removal. This can be useful when removing a bag full of debris that might move within the trash bag and bulge out and catch on inlet pipe, or possibly even rip the bag.

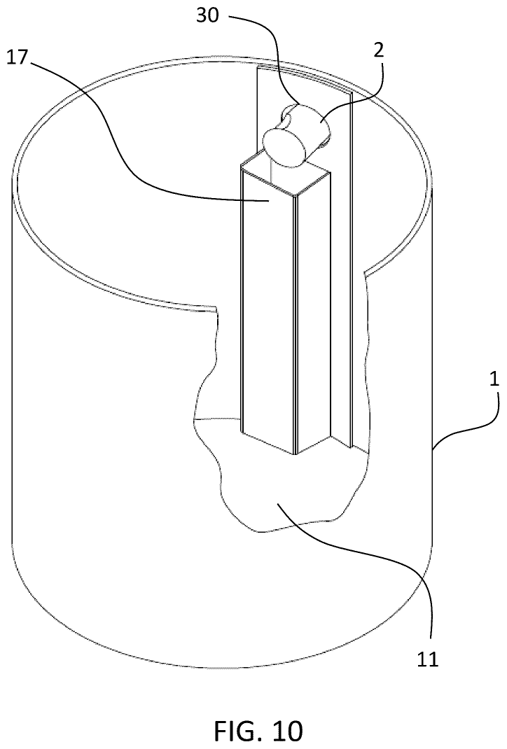

FIG. 9-10 illustrate one possible bag removal guide 17 of the present invention that can be installed within a canister vacuum canister. Illustrated bag removal guide 17 comprises a sleeve 28 of a width wider than a diameter of the inlet pipe 2 and of a length that extends to the bottom floor 11 of canister 1. Sleeve 28 also includes an opening 30 for positioning of bag removal guide 17 over debris inlet pipe 2. It is noted that for the purpose of illustration and discussion, the inlet pipes are shown to be round and tubular in shape. This may not be the case with all models of vacuums and must therefore be understood that the present invention applies to the other various shaped inlet pipes. Also included is a rectangular shaped channel 27 that when bag removal guide 17 is installed, extends from on or near the canister floor up to a height below the inlet pipe. Again, the rectangular shaped channel 27 can be of an alternate shape as long as it is wider than the inlet pipe and protrudes inward further than the inlet pipe with dimensions sufficient enough to prevent a bag from catching on the inlet pipe during bag removal.

FIG. 10 shows bag removal guide 17 installed inside canister 1, extending to floor 11, with opening 30 positioned over inlet pipe 2. The bag removal guide 17 must be installed into a canister before the bag is installed, and as with bag retainers, a bag removal guide 17 must allow the flow of debris to enter inside the trash bag.

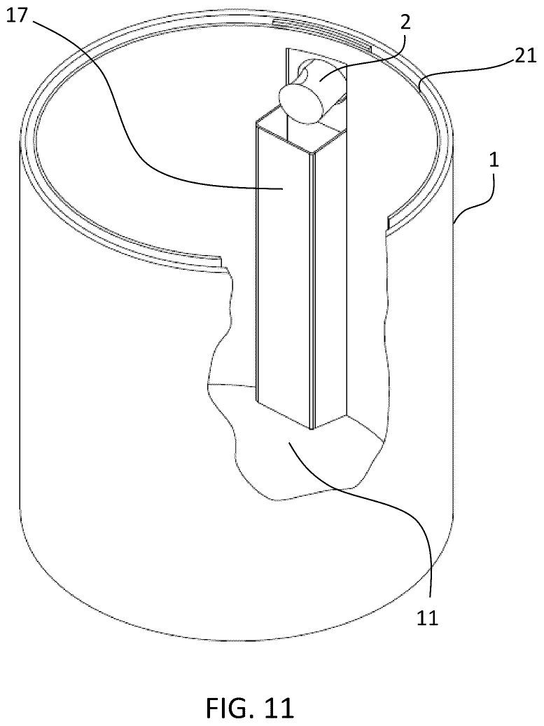

FIG. 11 illustrates bag removal guide 17 installed in canister 1 being used in conjunction with the bag retainer 15 of FIG. 7. Bag removal guide 17 might also be used with retainer sleeve 14 of FIG. 5, or even with another preferred retainer design that provides for installation by sliding the retainer down along each side of removal guide 17 to provide retention of the containment trash bag (not illustrated) during operation. It must be noted however that one needs to provide sufficient clearance between the bag removal guide, and the bag retainer, to allow installation of the bag retainer with a trash bag installed between, without damaging the bag.

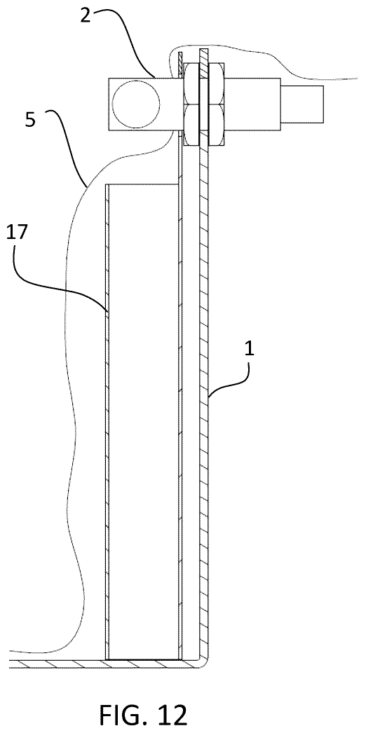

FIG. 12 illustrates bag removal guide 17 having been installed first as required, positioned behind trash bag 5 within canister 1.

It should be noted, that alternatively, a bag removal guide can also comprise of a fully enclosed single piece hollow sleeve (such as for example having a shape resembling retainer 22 of FIG. 8a). A one piece enclosed hollow sleeve fitted within a canister that extends from the bottom of the canister to a height level with the rim of the canister will provide the maximum benefit of ensuring the easiest bag removal.

Also to be noted is that a bag removal guide might be constructed so it can be permanently fastened within the canister. Additionally during permanent installation, and into a canister vacuum that is designed for both dry and wet vacuuming, one must ensure there are one or more openings through or below the bottom perimeter of the bag removal guide to allow vacuumed up liquid to exit from within the bag removal guide area out to the canister drain pipe.

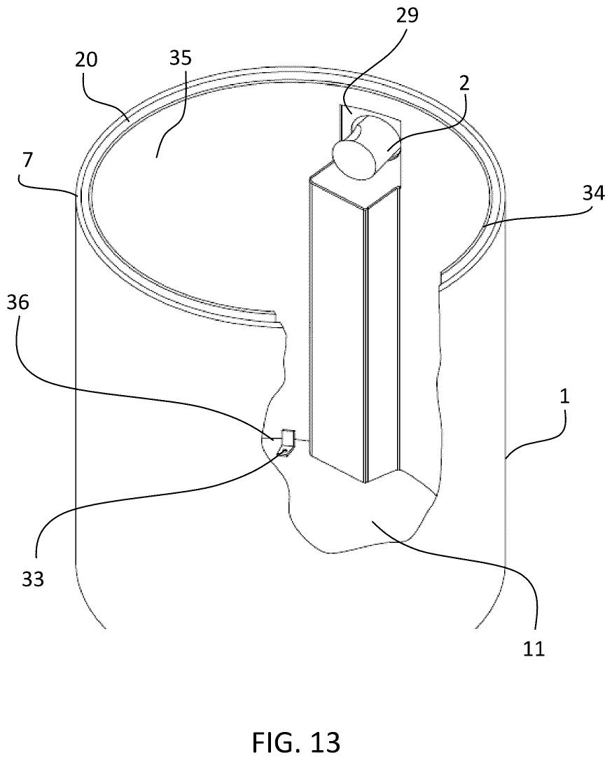

FIG. 13 depicts a fully enclosed single piece bag removal guide 34 comprised of hollow sleeve 35 that extends from near the bottom of canister 1 to height level with rim 7 for providing the maximum amount of guiding of a debris filled bag during removal. Also depicted is a means for permanently installing bag removal guide 34 within canister 1 through use of attachment tabs, such as depicted tab 33, located on the inside of sleeve 35. The tab is located inside bag removal guide sleeve 35 to allow installation of guide 34 down through top opening 20 of canister 1. Tabs such as depicted tab 33 can then be used for fastening bag removal guide 34 to floor 11 of canister 1. Other means of attachment can be utilized but need to be positioned in a manner that does not impede installation of the bag removal guide itself during installation. Additionally depicted is the tab 33 being located on sleeve 35 in a position to provide an opening or gap 36 between floor 11 and removal guide 34, to allow liquid to be drained out of a canister drain pipe (not shown) for a wet/dry canister vacuum application. An alternative to a providing a gap between the floor and removal guide is to provide holes or slots or other type openings near the bottom of the removal guide for draining. It needs to be noted that for wet vacuuming, a bag and bag retainer would not be utilized.

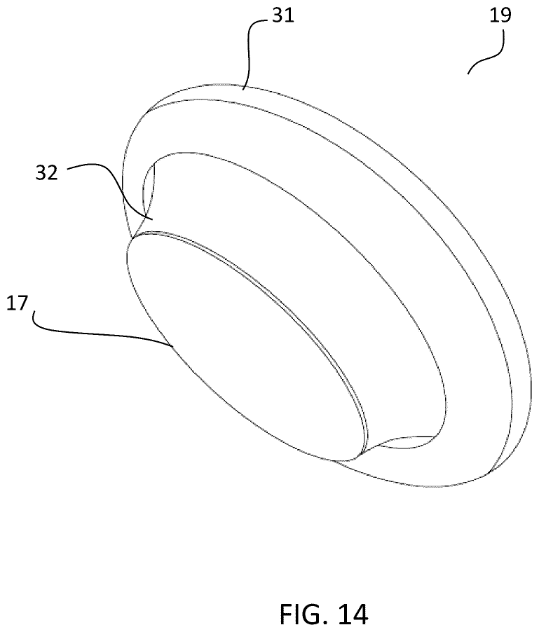

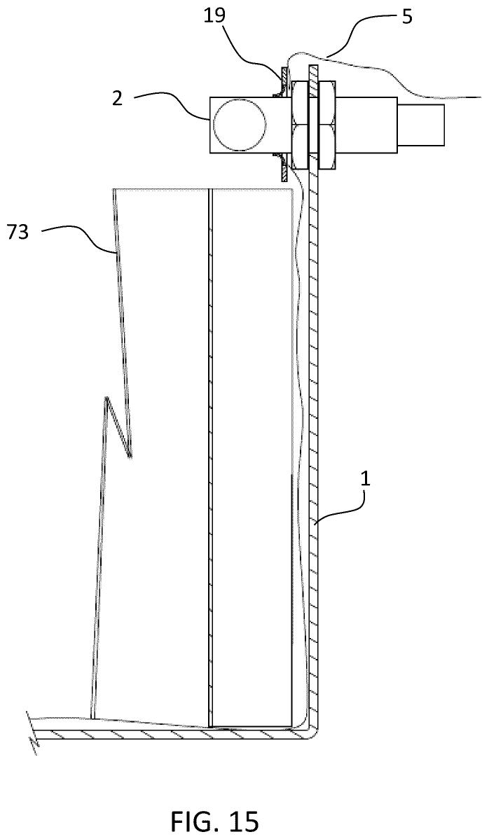

FIGS. 14-15 depicts one possible bag retaining washer 19 of the present invention. FIG. 14 illustrates bag retaining washer 19 for installation over a debris inlet pipe 2. A bag retaining washer such as retaining washer 19 is an option to further retain a bag in position behind the incoming debris flow. This can help prevent debris from depositing behind the containment bag, especially when utilizing a bag retainer having a height that is below the inlet pipe. The retaining washer 19 can be of any preferred shape and size but is illustrated in FIG. 14 to be round in shape, comprising of a sufficiently rigid outer washer 31 and including an attached flexible membrane 32, whereby outer washer 31 is to be assumed to be illustrated having an outside diameter of at least 50 mm larger than debris inlet pipe 2 diameter, and an inner diameter at least 25 mm smaller than its outside diameter, with a flexible membrane attached to washer 31 having an opening 17 that is sized at least 6 mm smaller in diameter than the outside of the debris inlet pipe 2, to in turn sufficiently secure retaining washer 19 on inlet pipe 2 and without requiring undue effort by the end user to remove. It is to be noted that the shape and sizes above are for illustrative purposes only, and can be another desired shape and size to best provide retention of the bag on a particular inlet pipe. During emptying of a canister vacuum, the bag retaining washer would be removed to allow removal of the bag for disposal.

FIG. 15 is a partial section view illustrating a bag retaining washer 19 installed over debris inlet pipe 2 to retain bag 5 in position on inlet pipe 2 behind the incoming debris flow. This may be preferred when utilizing a short bag retainer such as illustrated bag retainer 73 having a height stopping below the inlet pipe. This combination of a short bag retainer and a bag retaining washer will help ensure that all the incoming debris deposits within the containment bag.

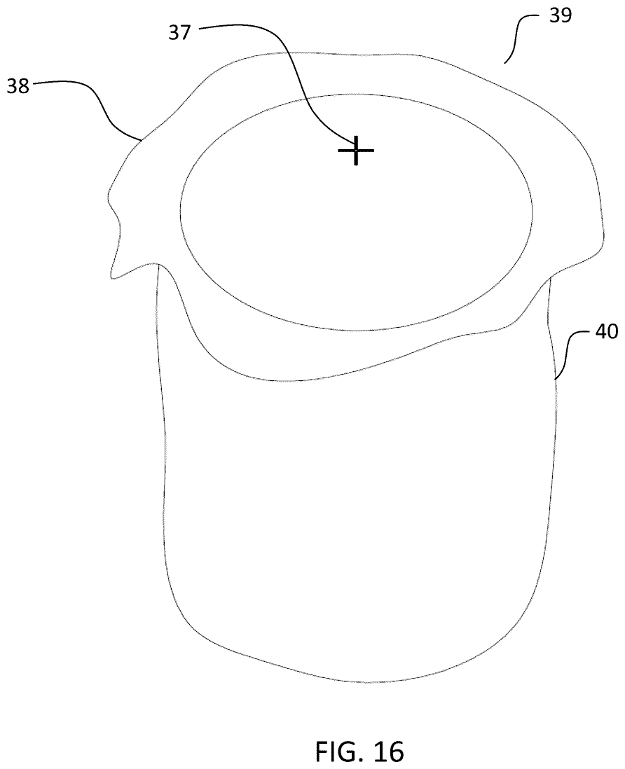

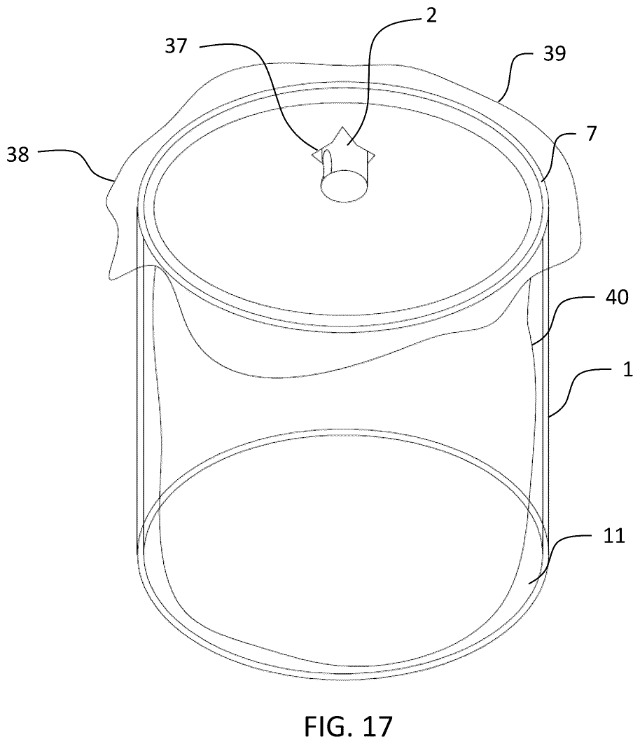

FIG. 16-17 depict a containment trash bag specifically designed for use in a canister vacuum where the canister vacuum canister includes a debris inlet pipe.

FIG. 16 illustrates a trash bag 39 including a simple cross shaped cut bag opening 37, cut through bag sidewall 40 of a body of a trash bag 39, with the cross shaped bag opening 37 of a length or height and width near to the length or height and width dimensions of the inlet pipe. The trash bag 39 has a bottom connected to the sidewalls 40 and a central opening. The cross cut bag opening 37 allows the end user to install the bag opening over the inlet pipe of a canister vacuum. Again, this is required so the flow of debris enters inside the trash bag. It is also noted that bag opening 37 can simply be a cross cut as depicted, or might be a circular hole opening, or another preferred shaped opening. The trash bag 39 can be a LDPE (Low density polyethylene) bag, LLDPE (Linear Low density polyethylene) bag or a HDPE (High density polyethylene) bag.

FIG. 17 illustrates bag opening 37 having been positioned over inlet pipe 2 inside of canister 1. To determine the location of opening 37 and to ensure proper operation, the following criteria must be met. A bag must be of a size that when installed, rests on the bottom floor of the canister in a manner that allows the bag retainer to be installed without being held up by the bag. In other words, the retainer must be able to be installed without the end user having to force the retainer into position by deforming or stretching the bag. Next, the bag must be of a size such that top edge 38 of the bag extends out of the canister sufficiently enough to drape over rim 7 to in turn be retained by the installed powerhead (not shown). Having met this criteria, the location of bag opening 37 can be positioned anywhere in the bag sidewall 40 that can be positioned to fit over inlet pipe 2.

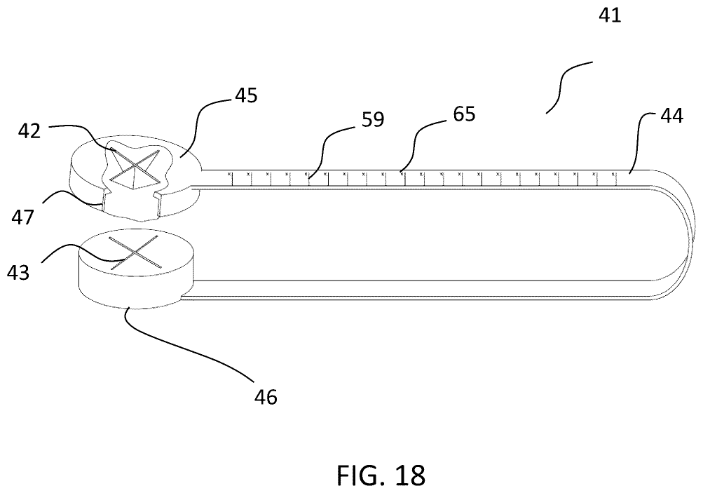

FIG. 18 depicts one possible design for a bag opening cutter of the present invention, whereby depicted bag opening cutter 41 includes a cross shaped cutter blade 42, attached to and extending down from a cutter blade mounting pad 45, with a cross shaped cutter slot opening 43 in slot pad 46 sized for cutter blade 42 to fit fully into, whereby flex handle 44 connects pads 45 and 46 and holds clearance between the pads during non-use that is sufficient to easily slide the bag material between. Additionally, the flex handle 44 provides a spring hinged type motion to allow pressing of cutter blade 42 into slot 43 for bag opening cutting plus to provide stability for sufficient alignment of cutter blade 42 with slot 43. Blade mounting pad 45 also includes a blade protector sleeve 47 for user safety and to slide down over pad 46 with clearance tight enough to provide some minimal gripping of the bag during cutting. Flex handle 44 is of a length to provide room to insert a sufficient amount of bag material inside flex handle 44 to allow positioning of cutter 41 to cut a bag in the desired location. FIG. 18 further depicts reference marks 59 with associated reference numbers or letter placed adjacent to each mark to aid the end user in making repeated cuts in bags over time.

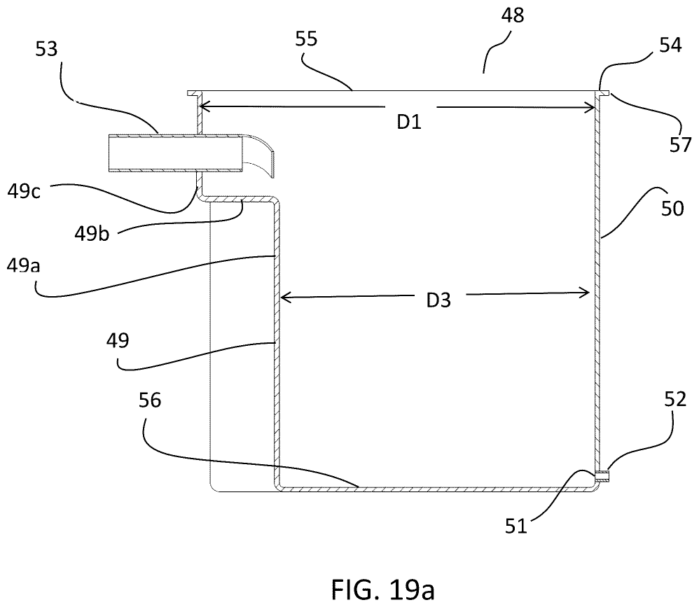

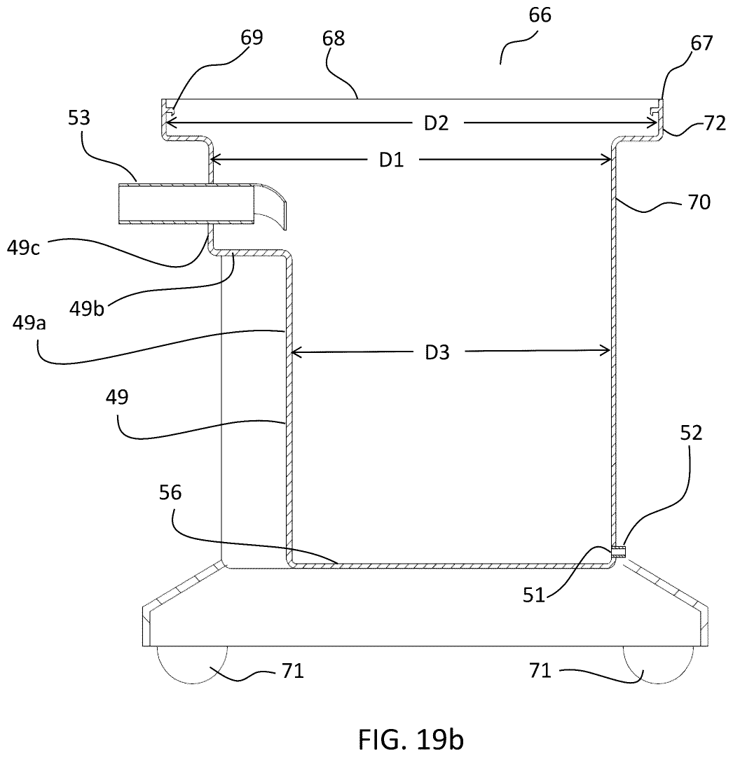

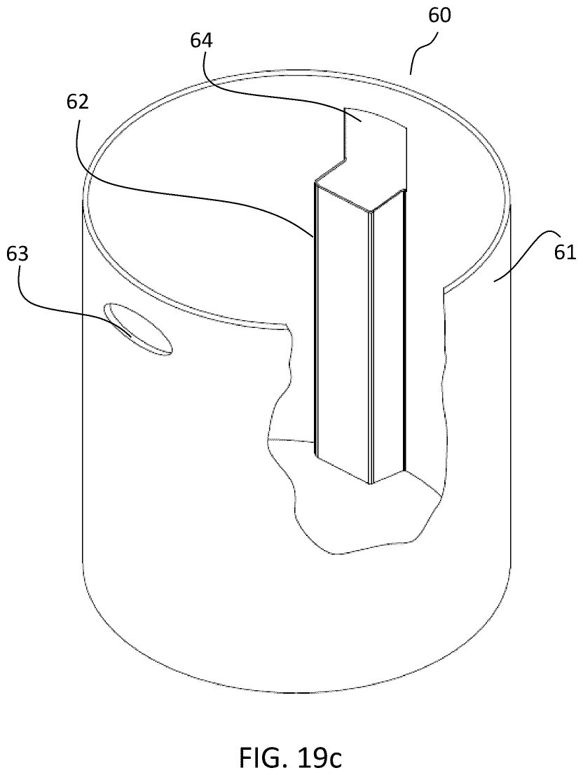

FIG. 19a-19b depict two possible canister configurations of the present invention configured to better optimize the use of a trash type bag for debris containment in a canister vacuum.

FIG. 19a depicts a partial section view of a canister 48, whereby canister 48 includes a channel shaped formed protrusion 49 in its side wall 50 and protruding inward a distance sufficient for guiding a debris filled bag up past the debris inlet pipe 53 for removal of the bag out through canister opening 55. The protrusion 49 can take the shape of a rectangular channel or a trapezoidal shape or a semi-circular channel or elliptical or another desired shaped protrusion where it is of a width wider than the width of inlet pipe 53 and of a length that extends from near or on the canister floor to a height just below inlet pipe 53 with enough clearance between sufficient for the end user to install the trash containment bag over inlet pipe 53. Additionally, protrusion 49 might also extend entirely around the inside circumference of the canister, alternatively simply forming a bottom cylindrical section that is smaller in diameter than the protruding depth of the inlet pipe. It is also noted that the canister shape might also be something other than cylindrical, but still shaped to allow a bag full of debris to be lifted out of the canister without hitting the inlet pipe. The protrusion 49 in this embodiment is formed of a first protrusion wall 49a, a transition wall 49b and a second protrusion wall 49c. It is noted that in this embodiment, a first diameter D1 is present between the side wall 50 and the second protrusion wall 49c associated with the inlet pipe 53. Another diameter D3 is present between the side wall 50 and the first protrusion wall 49a of the protrusion 49. The first protrusion wall 49a extends axially from the bottom 56 and is connected to a transition wall 49b. The transition wall 49b is parallel to the bottom 56. Connected to the transition wall 49b is a second protrusion wall 49c. The second protrusion wall 49c is also connected to the rim 57. It is to be noted that side wall 70, protrusion 49, and associated wall sections 49a, 49b, and 49c, are shown oriented vertically and horizontally and with some at 90 degrees to one another, however, this is for illustration only and can be manufactured at required or desired angles, while still performing the needed task of bettering bag removal.

Also depicted is a dry/wet vacuum configuration having a drain opening 51 installed through side wall 50 with a connected drain pipe 52 near the bottom 56 of canister 48 for draining vacuumed up liquid. Again, for use in vacuuming up a liquid such as water, a trash bag and bag retainer would not be installed.

Applicant notes that in the particular example illustrated in FIG. 19a, the depicted side wall 50 extends up to rim 54 without protruding inward (excluding protrusion 49) along its entire length so that a debris filled bag can be removed smoothly out through canister opening 55 without interference when being pulled out of the canister. Additionally depicted is a possible powerhead attachment flange 57 that extends outward from rim 54 to again prevent any bag removal interference. Powerhead attachments might also be positioned to extend upward instead of outward to again ensure interference does not occur during bag removal.

Another example configuration is shown in FIG. 19b in which canister 66 is of the same design as canister 48 of FIG. 19a except side wall 70 of canister 66 has an additional upper section 72 with a diameter D2 that is larger than the diameters D1, D3 of the rest of the canister 66. The upper section 72 incorporates an inward facing powerhead attachment design, for example attachment hooks 69, which protrude inwards and has a rim 67, but outside the area that would cause interference during bag removal. The canister 66 also includes a channel shaped formed protrusion 49 in its side wall 70 for guiding a debris filled bag up past the debris inlet pipe 53 for removal of the bag out through canister opening 68. The protrusion 49 in this embodiment is formed of a first protrusion wall 49a, a transition wall 49b and a second protrusion wall 49c. The first protrusion wall 49a extends axially from the bottom 56 and is connected to a transition wall 49b. The transition wall 49b is parallel to the bottom 56. Connected to the transition wall 49b is a second protrusion wall 49c. The second protrusion wall 49c is also connected to the upper section 72. The length of the transition wall 49b is preferably greater than the length of the debris inlet pipe 53 extending into the opening 68 of the canister. It is noted that in this embodiment, a first diameter D1 is present between the side wall 70 and the second protrusion wall 49c associated with the inlet pipe 53. Another diameter D3 is present between the side wall 70 and the first protrusion wall 49a of the protrusion 49. It is noted that protrusion 49 might also extend entirely around the inside circumference of the canister, alternatively simply forming a bottom cylindrical section that is smaller in diameter than the protruding depth of the inlet pipe. Once again, the canister shape might also be something other than cylindrical, but still shaped to allow a bag full of debris to be lifted out of the canister without hitting the inlet pipe. Side wall 70, protrusion 49, and associated wall sections 49a, 49b, and 49c, are shown oriented vertically and horizontally and with some at 90 degrees to one another, however, this is for illustration only and can be manufactured at required or desired angles, while still performing the needed task of bettering bag removal.

FIG. 19b further depicts one or more wheels, such as caster wheels 71 can be attached to the bottom of the canister outside of the canister opening.

FIG. 19c depicts a possible bag retainer 60 for use within either canister 48 or 66, whereby bag retainer 60 comprises a single piece hollow retaining sleeve 61 that would rest atop the bag resting upon floor 56 of canister 48 or 66, having an outside diameter that will allow for installation and removal. Depicted retainer 60 is also illustrated having a slot or oval shaped cutout 63 for use as a handle in conjunction with inlet pipe opening 64 during retainer installation and removal. Depicted retainer 60 includes channel 62 that protrudes inward and is dimensioned with clearance to surround formed protrusions 49 of canisters 48 and 66 and with sufficient clearance to not damage the installed trash bag when sliding retainer 60 down into the canisters. Depicted bag retainer 60 has an upward height that extends near to a height that is level with rim 54 of canister 48 in FIG. 19a, but could also be used in canister 66 of FIG. 19b. The combined use of an optimized canister and a retainer such as retainer 60, can provide maximum use of canister volume for the debris containment volume, as well being more user friendly when using a debris containment bag.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention

### DRAWING NUMBERS

1. canister
2. debris inlet pipe
3. debris
4. bag retainer
5. trash bag/debris containment bag
6. cut bag opening
7. rim
8. bag retainer
9. sleeve
10. opening
11. bottom floor
12. bag retainer
13. sleeve
14. sleeve
15. bag retainer
16. upper support section
17. bag removal guide
18. sleeve
19. bag retaining washer
20. canister opening
21. sleeve
22. retainer
23. sleeve
24. channel
25. removed sleeve section
26. shorter removed sleeve section
27. channel
28. sleeve
29. opening
30. opening
31. outer washer
32. flexible membrane
33. attachment tab
34. bag removal guide
35. sleeve
36. opening
37. cut bag opening
38. bag top edge
39. bag
40. bag side wall
41. bag opening cutter
42. cutter blade
43. cutter slot opening
44. flex handle
45. cutter blade mounting pad
46. cross cutter slot pad
47. blade protector
48. optimized canister
49. formed protrusion
50. side wall
51. drain opening
52. drain pipe
53. debris inlet pipe
54. rim
55. canister opening
56. canister floor
57. flange
58. side wall
59. reference marks
60. bag retainer
61. sleeve
62. channel
63. cutout
64. inlet pipe opening
65. reference numbers or letters
66. optimized canister
67. rim
68. canister opening
69. attachment hook
70. side wall
71. caster wheels
72. upper section
73. bag retainer
100. typical canister vacuum configuration
101. powerhead
102. canister
103. motor and fan housing
104. cartridge air filter
105. latches
106. drain pipe
107. canister opening
108. rim
109. debris
110. debris inlet pipe
202. canister
207. canister opening
208. rim
210. debris inlet pipe
302. canister
307. canister opening
308. rim
310. inlet pipe
402. canister
407. opening
408. rim

I claim:

1. A bag retainer for a vacuum comprising a canister having a bottom connected to walls defining a canister opening with a rim, and a debris inlet pipe directing vacuumed up debris into the canister, the bag retainer comprising:
a hollow, open-ended sleeve shaped and sized to fit within the canister opening having a first edge and a second edge;
wherein a bag is held in place within the canister opening by at least the second edge of the hollow, open ended sleeve within the bag and adjacent to the bottom of the canister and the bag extends over the rim of the canister opening, such that debris from the debris inlet pipe collects within the hollow, open-ended sleeve.

2. The bag retainer of claim 1, further comprising one or more openings in hollow, open-ended sleeve for providing user finger access to aid in removal of the bag retainer removal from the canister.

3. The bag retainer of claim 1, further comprising an opening located and sized to fit around a debris inlet pipe.

4. The bag retainer of claim 3, further comprising one or more openings in hollow, open-ended sleeve for providing user finger access to aid in bag retainer removal from the canister.

5. The bag retainer of claim 1, further comprising a shaped channel contiguous to the hollow, open-ended sleeve extending from the second edge towards the first edge, the shaped channel protruding radially inwards within the hollow, open-ended sleeve at least a length greater than a length of the debris inlet pipe extending within the canister opening and a width greater than a width of the debris inlet pipe.

6. The bag retainer of claim 5, further comprising one or more openings in hollow, open-ended sleeve for providing user finger access to aid in removal of the bag retainer.

7. The bag retainer of claim 5, wherein the shaped channel further defines an opening located and sized to fit around the debris inlet pipe proximal to the first edge.

8. The bag retainer of claim 3, wherein the open-ended sleeve is comprised of:
a first C-shaped sleeve section having a first end and a second end, defining a first C-shaped sleeve section opening between the first end and the second end; and
a second sleeve section defining an opening sized to receive the debris inlet pipe, the second sleeve section of a width greater than the first C-shaped sleeve section opening between the first end and the second end of the first C-shaped sleeve section, such that the second sleeve section overlaps the first end and the second end of the first C-shaped section.

9. The bag retainer of claim 3, further comprising at least one cutout extending from second edge towards first edge, such that a connecting portion is present between the at least one cutout and the first edge, the at least one cutout being sized to encompass the debris inlet pipe.

10. The bag retainer of claim 1, wherein the vacuum is selected from a group consisting of: canister vacuums, central vacuums, drum vacuums, wet/dry vacuums and shop vacuums.

11. The bag retainer of claim 1, wherein the bag is a garbage bag.

12. A removable bag guide for a vacuum comprising a canister having a bottom connected to walls defining a canister opening with a rim, a debris inlet pipe with an outlet in the canister opening, the removable bag guide comprising:
a hollow, open-ended sleeve in contact with the bottom of a canister, shaped and sized to fit within the canister opening having a first edge and a second edge adjacent the bottom of the canister, the hollow open-ended sleeve comprising a shaped channel contiguous to the hollow, open-ended sleeve extending from the second edge towards the first edge, the shaped channel protruding radially inwards within the hollow, open-ended sleeve at least a length greater than a length of the debris inlet pipe extending within the canister opening and a width greater than a width of the debris inlet pipe

13. The removable bag guide of claim 12, wherein the second edge of the hollow, open-ended sleeve is secured to the bottom of the canister.

14. The removable guide of claim 12, further comprising an opening sized to fit around the debris inlet pipe.

15. The removable guide of claim 12 further comprising at least one opening adjacent to bottom of canister to allow passage of liquid outside of hollow, open-ended sleeve.

16. A removable bag guide for a vacuum comprising a canister having a bottom connected to walls defining a canister opening with a rim, a debris inlet pipe with an outlet in the canister opening, the removable bag guide comprising:
a shaped channel having a first edge and a second edge, protruding radially inwards at least a depth greater than a depth of the debris inlet pipe within the canister opening and a width at least wider that a width of the debris inlet pipe and to a height below any debris within the canister.

17. The removable bag guide of claim 16, wherein the shaped channel defines an opening sized to fit around the debris inlet pipe.

18. The removable bag guide of claim 16, wherein the second edge of the hollow, open-ended sleeve is secured to the bottom of the canister.

19. A bag for a vacuum comprising a canister having a bottom connected to walls defining a canister opening with a rim, a debris inlet pipe with an outlet in the canister opening, the bag comprising: a body with sidewalls having a bottom and defining a central opening, wherein at least one of the sidewalls has a cut bag opening sized to accept the debris inlet pipe within the canister of the vacuum.

20. A canister for a canister vacuum comprising:
a canister body having a bottom connected to walls defining a canister opening with a rim, a debris inlet pipe with an outlet in the canister opening, wherein at least one of the walls has a first section connected to a second section separated by a transition section, the second section receiving the debris inlet pipe and the transition section having a length greater than the length of the debris inlet pipe within the canister opening.

21. The canister of claim 20, further comprising a drain in or adjacent to the bottom.

22. The canister of claim 20, further comprising one or more wheels attached to the bottom of the canister outside of the canister opening.

23. A canister for a canister vacuum comprising:
a canister body having a bottom connected to walls defining a canister opening with a rim, a debris inlet pipe with an outlet in the canister opening, wherein the walls have a first section connected to a second section separated by a transition section, the second section receiving the debris inlet pipe and the transition section having a length greater than the length of the debris inlet pipe within the canister opening.

24. The canister of claim 23, further comprising a drain in or adjacent to the bottom.

25. The canister of claim 23, further comprising one or more wheels attached to the bottom of the canister outside of the canister opening.

26. A bag retaining washer for retaining a bag over a debris inlet pipe within a vacuum comprising:
a substantially rigid outer structure defining an opening having with a fixedly attached flexible membrane sized to install over and on the debris inlet pipe.

27. A bag cutter comprising:
a resilient handle having a first end and a second end, the first end being opposite of the second end;
a cross-shaped blade mounted to the first end; and
a cross-shaped slot sized to receive the cross-shaped blade in the second end;
wherein the u-shaped handle has a first position and a second position, such that in a first position, the first end is spaced apart from the second end a distance, such that a bag can pass between the first end and the second end and in the second position, the cross-shaped blade is received within the cross-shaped slot, passing through the bag present between the first end and the second end, cutting a cross-shaped hole.

28. The bag cutter of claim 27, further comprising reference marks on the handle to aid a user in making repeated cuts in multiple bags.
